(19) United States
(12) Patent Application Publication
(10) Pub. No.: US 2021/0102313 A1
(43) Pub. Date: Apr. 8, 2021

(54) HIGH PERFORMANCE FIBRES HYBRID SHEET

(71) Applicant: DSM IP Assets B.V., Heerlen (NL)

(72) Inventors: Roelof MARISSEN, Echt (NL); Robert COHNEN, Echt (NL); Johannes Petrus Marinus PLUG, Echt (NL); Leonard NIELABA, Echt (NL)

(21) Appl. No.: 16/499,943

(22) PCT Filed: Apr. 3, 2018
(86) PCT No.: PCT/EP2018/058386

§ 371 Date: Oct. 1, 2019

(30) Foreign Application Priority Data
Apr. 3, 2017 (EP) 17164455.2

(51) Int. Cl. D01F 8/06; D01D 5/08; D01F 8/18; D06M 15/227; D01F 11/06; D01F 1/02

(52) U.S. Cl. CPC D01F 8/06; D01D 5/082; D01F 8/18; D06M 2101/18; D01F 11/06; D01F 1/02; D06M 15/227

(57) ABSTRACT

The present invention relates to hybrid sheet comprising: i) high-performance polyethylene (HPPE) fibers; ii) a polymeric resin, wherein the polymeric resin is selected from a group consisting of a homopolymer of ethylene, a homopolymer of propylene, a copolymer of ethylene, and a copolymer of propylene and wherein said polymeric resin has a density as measured according to ISO1183-2004 in the range from 860 to 970 kg/m³, a peak melting temperature in the range from 40 to 140° C. and a heat of fusion of at least 5 J/g; iii) non-polymeric fibers; and iv) optionally, a matrix material. Furthermore, the present invention relates to a process to manufacture the hybrid sheet and to the use of the hybrid sheet in various fields, such as in automotive field, in aerospace field, in sports equipment, in marine field, in military field; and in wind and renewable energy field.

The present invention relates to a hybrid sheet comprising high-performance polyethylene fibers and non-polymeric fibers. The invention also relates to a process to manufacture said sheet. Furthermore, the present invention directs to the use of the hybrid sheet in various applications.

Hybrid materials comprising non-polymeric fibers, such as continuous hard fibers, like carbon fibers, glass fibers, basalt fibers, silicon carbide fibers or boron fibers, typically in a cured polymer matrix are well known in the art as being excellent structural materials. Of these, glass fibers and carbon fibers are mostly used. These materials are known to be light, strong, and stiff and therefore are increasingly applied in high performance structures, e.g. air planes, rockets, bridges, cars, bicycles, and various sporting goods, in fact they are applied in all applications where structural performance is important. However, these materials have at least one disadvantage, i.e. their impact resistance is very low or, in other words, their sensitivity to impact damage is very high.

It is also known in the art that this very high sensitivity to impact damage can be reduced by replacing part of these hard fibers by very strong polymeric fibers, such as high performance polyethylene (HPPE) fibers, this replacement considerably increasing the impact resistance of the composites. For instance, gel spun ultra-high molecular weight polyethylene (UHMWPE) fibers are known to be a very attractive option for this requirement. However, such strong polymeric fibers typically show only high strength under tensile loading, whereas other strength properties, like axial compression strength, are very low. Moreover, the adhesion of matrix materials to these polymeric fibers is known to be poor. Thus, the improvement of the impact resistance is penalized with a reduction in structural properties, like flexural strength. So, the replacement of the hard fibers by very strong polymeric fibers is mainly attractive for applications where impact resistance is dominant, while other structural properties may be sacrificed to a considerable extent. For instance, the problem of increasing impact resistance, at a penalty of decreasing structural performance is extensively discussed in literature, e.g. in Dyneema fibers in composites, the addition of special mechanical functionalities by R. Marissen, L. Smit, C. Snijder, in Advancing with composites 2005, Naples, Italy, Oct. 11-14, 2005, but no real solution is provided therein. This document particularly discloses epoxy resin reinforced with glass fiber fabrics and combined with Dyneema®/glass hybrid fabrics containing 57% by volume of Dyneema® and analyses these composites for safety, vibration damping or penetration resistance.

The prior art also provides some options for improving structural performance of composites at good impact resistance, e.g. to improve the adhesion of the HPPE, i.e. UHMWPE fibers to the composite matrix material by applying corona or plasma treatment to the fibers, or by strong oxidizing treatments of the fibers, e.g. with permanganates. Many examples of such treatments exist, varying in intensity and plasma composition. All such treatments have in common that they cause a reduction of the fiber strength, thus a reduction of the composite performance, e.g. of impact resistance and strength decrease requires, or requires an extra processing step and thus increase manufacturing costs. Moreover, these treatments lose effectivity after long storage time, meaning that manufacturing of such composite should be carried out within only few weeks after the fiber treatment, which is not always possible.

It is the aim of the present invention to therefore provide a hybrid material that at least partly overcomes the above-mentioned problems. In particular, it is an aim of the present invention to provide a hybrid material showing improved structural properties, e.g. improved flexural strength and bending strength, while maintaining high impact resistance properties, and thus enabling more and various application opportunities.

This objective is achieved according to the present invention by a hybrid sheet comprising: i) high-performance polyethylene (HPPE) fibers; ii) a polymeric resin, wherein the polymeric resin is selected from a group consisting of a homopolymer of ethylene, a homopolymer of propylene, a copolymer of ethylene, and a copolymer of propylene, wherein the polymeric resin has a density as measured according to ISO1183-2004 in the range from 860 to 970 kg/m³, a melting temperature in the range from 40 to 140° C. and a heat of fusion of at least 5 J/g; and ii) non-polymeric fibers.

It has unexpectedly been found that the hybrid sheet according to the present invention shows improved structural properties if it is applied in a hybrid composite, e.g. it shows improved flexural strength and bending strength without compromising on impact resistance properties.

By term “composite” is herein understood a material comprising fibers and a material in a different form, such as a matrix material, e.g. a co(polymer) resin impregnated through the fibers and/or coated on the fibers. The matrix material is typically a liquid (co)polymer resin impregnated in between the fibers and optionally subsequently hardened. Hardening or curing may be done by any means known in the art, e.g. a chemical reaction, or by solidifying from molten to solid state. Suitable examples include thermoplastic or thermoset resins, epoxy resins, polyester or vinylester resins, or phenolic resins. The hybrid sheet according to the present invention wherein the matrix material iii) is present may be also referred herein as hybrid composite sheet.

By term “hybrid” composites is herein understood a composite comprising at least two different kind of fibers, whereas the fibers have different chemical structure and properties.

By term “fiber” is herein understood an elongated body, the length dimension of which is much greater than the transverse dimensions of width and thickness. Accordingly, the term fiber includes filament, ribbon, strip, band, tape, and the like having regular or irregular cross-sections. The fiber may have continuous lengths, known in the art as filament or continuous filament, or discontinuous lengths, known in the art as staple fibers. A “yarn” for the purpose of the invention is an elongated body containing many individual fibers. By “individual fiber” is herein understood the fiber as such. Preferably the HPPE fibers of the present invention are HPPE tapes, HPPE filaments or HPPE staple fibers.

By “warp yarn” is generally understood the yarns that run substantially lengthwise, i.e. in the machine length direction of the fabric. In general, the length direction is only limited by the length of the warp yarns whereas the width is mainly limited by the number of individual warp yarns and the width of the weaving machine employed. The sheet according of the invention may be a woven fabric that may have multiple warp yarns with similar or different composition.

By term “weft yarn” is generally understood the yarns that run in a cross-wise direction, i.e. transverse to the machine direction of the fabric. Defined by a weaving sequence of the product, the weft yarn repeatedly interlaces or interconnects with at least one warp yarn. The angle formed between the warp yarns and the weft yarns can vary from 15 to 90, for instance be about 90° or 45 or 30. The hybrid sheet according of the invention may be a woven fabric that may comprise one single weft yarn or multiple weft yarns with similar or different composition.

In the context of the present invention, a fabric can be of any type known in the art, for instance woven, non-woven, knitted, netted or braided and/or a technical fabric. These types of fabrics and way of making them are already known to the skilled person in the art. The areal density of fabrics is preferably between 10 and 2000 g/m², more preferably between 100 and 1000 g/m² or between 150 and 500 g/m². Suitable examples of woven fabrics include plain or tabby weaves, twill weaves, basket weaves, satin weaves, crow feet weaves, and triaxial weaves. Suitable examples of non-woven fabrics include unidirectional (UD) fibers, stitched fibers, veil and continuous strand mat.

A fabric is known in the art to be a three-dimensional (3D) object, wherein one dimension (the thickness) is much smaller than the two other dimensions (the length or the warp direction and the width or weft direction). In general, the length direction is only limited by the length of the warp yarns whereas the width of a fabric is mainly limited by the count of individual warp yarns and the width of the weaving machine employed. The position of the warp yarns is defined according to their position across the thickness of the fabric, whereby the thickness is delimited by an outside and an inside surface. By ‘outside’ and ‘inside’ is herein understood that the fabric comprises two distinguishable surfaces. The terminology ‘outside’ and ‘inside’ should not be interpreted as a limiting feature rather than a distinction made between the two different surfaces. It may as well be that for specific uses the surfaces will be facing the opposite way or that the fabric is folded to form a double layer fabric with two identical surfaces exposed on either side while the other surfaces are turned towards each other.

The weave structure typically formed by the warp yarns and the weft yarns in a woven fabric can be of multiple types, as known in the art, depending upon the number and diameters of the employed warp yarns and weft yarns as well as on the weaving sequence used between the warp yarns and the weft yarns during the weaving process. Such different sequences are well known to the person skilled in the art. Through the weaving process, the weft yarn typically interweaves the warp yarns, hereby partially interconnecting the outside and inside layers comprising respectively said warp yarns. Such interweaved structure may also be called a monolayer fabric even though such monolayer may be composed of sub layers as described above. Weaving of tapes is also known per se, for instance from document WO2006/075961, which discloses a method for producing a woven layer from tape-like warps and wefts comprising the steps of feeding tape-like warps to aid shed formation and fabric take-up; inserting tape-like weft in the shed formed by said warps; depositing the inserted tape-like weft at the fabric-fell; and taking-up the produced woven monolayer; wherein said step of inserting the tape-like weft involves gripping a weft tape in an essentially flat condition by means of clamping, and pulling it through the shed. When weaving tapes specially designed weaving elements are commonly used. Particularly, suitable weaving elements are described in U.S. Pat. No. 6,450,208.

A weave structure is typically characterized in the prior art by a float, a length of the float and a float ratio. The float is a portion of a weft yarn delimited by two consecutive points where the weft yarn crosses the virtual plane formed by the warp yarns. The length of the float expresses the number of warp yarns that the float passes between said two delimiting points. Typical lengths of floats may be 1, 2 or 3, indicating that the weft yarn passes 1, 2 or 3 warp yarns before crossing the virtual plane formed by the warp yarns by passing between adjacent warp yarns. The float ratio is the proportion between the lengths of the floats of the weft yarn on either side of the plane formed by the warp yarns. Typically, the weave structure of the outside layer has float ratios of 3/1, 2/1 or 1/1. The weave structure for the inside layer may be chosen independent form the outside layer. For instance, depending upon the composition of the warp yarns and the weft yarns the weave structure of the inside layer may have a float ratios of 3/1, 2/1 or 1/1.

Preferably, the hybrid sheet comprises or consists of: i) HPPE fibers; ii) a polymeric resin, wherein the polymeric resin is a homopolymer of ethylene or propylene or is a copolymer of ethylene and/or propylene, wherein the polymeric resin has a density as measured according to ISO1183-2004 in the range from 860 to 970 kg/m³, a melting temperature in the range from 40 to 140° C. and a heat of fusion of at least 5 J/g, iii) non-polymeric fibers; and iv) a matrix material.

In the context of the present invention, HPPE fibers are understood to be polyethylene fibers with improved mechanical properties such as tensile strength, abrasion resistance, cut resistance or the like. Preferably, high performance polyethylene fibers comprise or consist of polyethylene fibers with a tensile strength of at least 1.0 N/tex, more preferably at least 1.5 N/tex, more preferably at least 1.8 N/tex, even more preferably at least 2.5 N/tex and most preferably at least 3.5 N/tex, particularly on a yarn level, measured according to the method in the Example section of this patent application. Preferred polyethylene is high molecular weight (HMWPE) or ultrahigh molecular weight polyethylene (UHMWPE). Best results were obtained when the high-performance polyethylene fibers comprise ultra-high molecular weight polyethylene (UHMWPE) and have a tenacity of at least 2.0 N/tex, more preferably at least 3.0 N/tex, particularly on a yarn level, measured according to the method in the Example section of this patent application.

Preferably, the hybrid sheet of the present invention comprises HPPE fibers comprising high molecular weight polyethylene (HMWPE) or ultra-high molecular weight polyethylene (UHMWPE) or a combination thereof, preferably the HPPE fibers substantially consist of HMWPE and/or UHMWPE. The inventors observed that for HMWPE and UHMWPE the best composite performance could be achieved.

In the context of the present invention the expression ‘substantially consisting of’ has the meaning of ‘may comprise a minor amount of further species’ wherein minor is up to 5 wt %, preferably of up to 2 wt % of said further species or in other words ‘comprising more than 95 wt % of’ preferably ‘comprising more than 98 wt % of’ HMWPE and/or UHMWPE.

In the context of the present invention, the polyethylene (PE) may be linear or branched, whereby linear polyethylene is preferred. Linear polyethylene is herein understood to mean polyethylene with less than 1 side chain per 100 carbon atoms, and preferably with less than 1 side chain per 300 carbon atoms; a side chain or branch generally containing at least 10 carbon atoms. Side chains may suitably be measured by FTIR. The linear polyethylene may further contain up to 5 mol % of one or more other alkenes that are copolymerisable therewith, such as propene, 1-butene, 1-pentene, 4-methylpentene, 1-hexene and/or 1-octene.

The PE is preferably of high molecular weight with an intrinsic viscosity (IV) of at least 2 dl/g; more preferably of at least 4 dl/g, most preferably of at least 8 dl/g. Such polyethylene with IV exceeding 4 dl/g are also referred to as ultra-high molecular weight polyethylene (UHMWPE). Intrinsic viscosity is a measure for molecular weight that can more easily be determined than actual molar mass parameters like number and weigh average molecular weights (Mn and Mw).

The HPPE fibers used according to the invention may be obtained by various processes, for example by a melt spinning process, a gel spinning process or a solid-state powder compaction process.

One preferred method for the production of the HPPE fibers is a solid-state powder process comprising the feeding the polyethylene as a powder between a combination of endless belts, compression-molding the polymeric powder at a temperature below the melting point thereof and rolling the resultant compression-molded polymer followed by solid state drawing. Such a method is for instance described in U.S. Pat. No. 5,091,133, which is incorporated herein by reference. If desired, prior to feeding and compression-molding the polymer powder, the polymer powder may be mixed with a suitable liquid compound having a boiling point higher than the melting point of said polymer. Compression molding may also be carried out by temporarily retaining the polymer powder between the endless belts while conveying them. This may for instance be done by providing pressing platens and/or rollers in connection with the endless belts.

Another preferred method for the production of the HPPE fibers used in the invention comprises feeding the polyethylene to an extruder, extruding a molded article at a temperature above the melting point thereof and drawing the extruded fibers below its melting temperature. If desired, prior to feeding the polymer to the extruder, the polymer may be mixed with a suitable liquid compound, for instance to form a gel, such as is preferably the case when using ultra high molecular weight polyethylene.

In yet another method the HPPE fibers used in the invention are prepared by a gel spinning process. A suitable gel spinning process is described in for example GB-A-2042414, GB-A-2051667, EP 0205960 A and WO 01/73173 A1. In short, the gel spinning process comprises preparing a solution of a polyethylene of high intrinsic viscosity, extruding the solution into a solution-fiber at a temperature above the dissolving temperature, cooling down the solution-fiber below the gelling temperature, thereby at least partly gelling the polyethylene of the fiber, and drawing the fiber before, during and/or after at least partial removal of the solvent.

In the described methods to prepare HPPE fibers drawing, preferably uniaxial drawing, of the produced fibers may be carried out by means known in the art. Such means comprise extrusion stretching and tensile stretching on suitable drawing units. To attain increased mechanical tensile strength and stiffness, drawing may be carried out in multiple steps.

In case of the preferred UHMWPE fibers, drawing is typically carried out uniaxially in a number of drawing steps. The first drawing step may for instance comprise drawing to a stretch factor (also called draw ratio) of at least 1.5, preferably at least 3.0. Multiple drawing may typically result in a stretch factor of up to 9 for drawing temperatures up to 120° C., a stretch factor of up to 25 for drawing temperatures up to 140° C., and a stretch factor of 50 or above for drawing temperatures up to and above 150° C. By multiple drawing at increasing temperatures, stretch factors of about 50 and more may be reached. This results in HPPE fibers, whereby for ultrahigh molecular weight polyethylene, tensile strengths of 1.5 N/tex to 3 N/tex and more may be obtained, particularly on a yarn level, measured according to the method in the Example section of this patent application.

By “non-polymeric fibers” is herein understood any fibers that do not contain a polymer. Alternative definition of non-polymeric fibers used in the present invention is fibers essentially not containing hydrogen atoms, which can be fibers that contain hydrogen atoms in an amount of less than 1 mass %, relative to the total mass of the fibers. Suitable examples of non-polymeric fibers according to the present invention are basalt fibers, wollastonite fibers, glass fibers and and/or carbon fibers known in the art.

The non-polymeric fiber may have a titer of from 100 dtex to 100000 dtex, preferably of from 100 dtex to 50000 dtex. In particular, the carbon fibers or basalt or glass fibers may have a titer of between 500 and 40000 dtex, in particular between 650 and 32000 dtex and a filament count may be between 1000 and 48000. Mixtures of glass fibers, carbon fibers, wollastonite fibers and/or basalt fibers may also be used in any ratio according to the present invention. Preferably, the non-polymeric fibers used according to the present invention are fibers selected from a group consisting of carbon fibers, glass fibers, basalt fibers and/or mixtures thereof, more preferably the non-polymeric fibers used according to the present invention are fibers selected from a group consisting of carbon fibers and glass fibers.

The polymeric resin present in the applied solution or suspension according to the process of the present invention and ultimately present in the hybrid sheet of the present invention is a homopolymer of ethylene or propylene or a copolymer of ethylene and/or propylene, also referred to as polyethylene, polypropylene or copolymers thereof, in the context of the present invention also referred to as polyolefin resin, being selected from a group consisting of a homopolymer of ethylene, a homopolymer of propylene, a copolymer of ethylene, and a copolymer of propylene. It may comprise the various forms of polyethylene, ethylene-propylene co-polymers, other ethylene copolymers with co-monomers such as 1-butene, isobutylene, as well as with hetero atom containing monomers such as acrylic acid, methacrylic acid, vinyl acetate, maleic anhydride, ethyl acrylate, methyl acrylate; generally, α-olefin and cyclic olefin homopolymers and copolymers, or blends thereof. Preferably, the polymeric resin is a copolymer of ethylene or propylene which may contain as co-monomers one or more olefins having 2 to 12 C-atoms, in particular ethylene, propylene, isobutene, 1-butene, 1-hexene, 4-methyl-1-pentene, 1-octene, acrylic acid, methacrylic acid and vinyl acetate. In the absence of co-monomer in the polymeric resin, a wide variety of polyethylene or polypropylene may be used amongst which high density polyethylene (HDPE), linear low density polyethylene (LLDPE), very low density polyethylene (VLDPE), low density polyethylene (LDPE), isotactic polypropylene, atactic polypropylene, syndiotactic polypropylene or blends thereof.

Furthermore, preferably the polymeric resin may be a functionalized polyethylene or polypropylene or copolymers thereof or alternatively the polymeric resin may comprise a functionalized polymer. Such functionalized polymers are often referred to as functional copolymers or grafted polymers, whereby the grafting refers to the chemical modification of the polymer backbone mainly with ethylenically unsaturated monomers comprising heteroatoms and whereas functional copolymers refer to the copolymerization of ethylene or propylene with ethylenically unsaturated monomers. Preferably, the ethylenically unsaturated monomer comprises oxygen and/or nitrogen atoms. Most preferably, the ethylenically unsaturated monomer comprises a carboxylic acid group or derivatives thereof resulting in an acylated polymer, specifically in an acetylated polyethylene or polypropylene. Preferably, the carboxylic reactants are selected from the group consisting of acrylic, methacrylic, cinnamic, crotonic, and maleic, amine, fumaric, and itaconic reactants. Said functionalized polymers typically comprise between 1 and 10 wt % of carboxylic reactant or more. The presence of such functionalization in the resin may substantially enhance the dispersability of the resin and/or allow a reduction of further additives present for that purpose such as surfactants. Preferably, ethylene acrylic acid (EAA) copolymer, such as the commercially available EAA copolymers sold under the tradename Michemprime®, is the polymeric resin used as this copolymer enhances adhesion to HPPE fibers and non-polymeric materials.

The polymeric resin has a density as measured according to ISO1183-2004 in the range from 860 to 970 kg/m³, preferably from 870 to 930 kg/m³, yet preferably from 870 to 920 kg/m³, more preferably from 875 to 910 kg/m³. The inventors identified that polyolefin resins with densities within said preferred ranges provide an improved balance between the mechanical properties of the composite article and the processability of the suspension, especially the dried suspension during the process of the invention.

The polymeric resin may be a semi-crystalline polyolefin and has a peak melting temperature in the range from 40 to 140° C. and a heat of fusion of at least J/g, measured in accordance with ASTM E793 and ASTM E794, considering the second heating curve at a heating rate of 10 K/min, on a dry sample. Preferably, the polymeric resin has a heat of fusion of at least 10 J/g, preferably at least 15 J/g, more preferably at least 20 J/g, even more preferably at least 30 J/a and most preferably at least 50 J/g. The heat of fusion of the polymeric resin is not specifically limited by an upper value, other than the theoretical maximum heat of fusion for a fully crystalline polyethylene or polypropylene of about 300 J/g. The polymeric resin is a semi-crystalline product with a peak melting temperature in the specified ranges. Accordingly, is a reasonable upper limit for the polymeric resin a heat of fusion of at most 200 J/g, preferably at most 150 J/g. Preferably, a peak melting temperature of the polymeric resin is in the range from 50 to 130° C., preferably in the range from 60 to 120° C. Such preferred peak melting temperatures provide a more robust processing method to produce the hybrid sheet in that the conditions for drying and/or compaction of the hybrid sheet do need less attention while composites with good properties are produced. The polymeric resin may have more than one peak melting temperatures. In such case, at least one of said melting temperatures falls within the above ranges. A second and/or further peak melting temperature of the polymeric resin may fall within or outside the temperature ranges. Such may for example be the case when the polymeric resin is a blend of polymers.

The polymeric resin may have a modulus that may vary in wide ranges. For instance, the modulus may vary from 50 MPa to 500 MPa, related to the specific demands during the use of the sheet according to the invention in different applications.

The polymeric resin is preferably in contact with the surface of the HPPE fibers, more preferably the polymeric resin has been applied as a coating on the surface of the HPPE fibers, most preferably the polymeric resin has been applied on the HPPE fibers as a coating obtained from an aqueous suspension, as the hybrid material shows improved structural properties, e.g. improved flexural strength and bending strength, while maintaining high impact resistance properties.

Preferably, the hybrid sheet according to the present invention comprises or consists of:
i) from 10 to 60 vol. % of the HPPE fibers, relative to the total volume of the hybrid sheet,
ii) from 0.5 to 40 vol % of the polymeric resin, relative to the total volume of the hybrid sheet, wherein the polymeric resin is selected from a group consisting of a homopolymer of ethylene, a homopolymer of propylene, a copolymer of ethylene, and a copolymer of propylene, wherein the polymeric resin has a density as measured according to ISO1183-2004 in the range from 860 to 970 kg/m³, a melting temperature in the range from 40 to 140° C. and a heat of fusion of at least 5 J/g; and
iii) from 40 to 89.5 vol % of the non-polymeric fibers, relative to the total volume of the hybrid sheet. The total sum of volumes of i)+ii) should not exceed 100%.

More preferably, the hybrid sheet according to the present invention comprises or consists of:
i) from 3 to 40 vol. % of the HPPE fibers, relative to the total volume of the hybrid sheet;
ii) from 0.15 to 30 vol % of the polymer resin, relative to the total volume of the hybrid sheet, wherein the polymeric resin is selected from a group consisting of a homopolymer of ethylene, a homopolymer of propylene, a copolymer of ethylene, and a copolymer of propylene, wherein the polymeric resin has a density as measured according to ISO1183-2004 in the range from 860 to 970 kg/m³, a melting temperature in the range from 40 to 140° C. and a heat of fusion of at least 5 J/g;
iii) from 17 to 60 vol % of the non-polymeric fibers, relative to the total volume of hybrid sheet, and
iv) from 80 to 30 vol % of the matrix material, relative to the total volume of the hybrid sheet. The total sum of volumes of i)+ii)+iii) should not exceed 100%.

Preferably, the amount of polymeric resin is of from 0.5 to 25 vol %, preferably of from 1 to 20 vol %, most preferably of from 2 to 18 vol %, yet most preferably of from 2 to 10 vol %, related to the volume of the polymeric resin in the total volume of the hybrid sheet.

Preferably, the hybrid sheet comprises at most 50 vol % of the HPPE fibers, more preferably at most 35 vol % of the HPPE fibers, yet more preferably from to 50 vol % of the HPPE fibers, yet more preferably from 15 to 35 vol % of the HPPE fibers, and most preferably from 5 to 30 vol % HPPE fibers, relative to the total volume of the hybrid sheet. Higher amounts of HPPE fibers result in lower values for mechanical properties. Lower amounts of HPPE fibers result in lower impact strength properties and decrease of penetration resistance (i.e. out-of-plane impact resistance).

Preferably, the amount of HPPE fiber on volume basis is equal to or lower than the amount of non-polymeric fiber in the hybrid fabric according to the invention. More preferably, the volume ratio of the HPPE fiber to the non-polymeric fiber is about 1:5 to 1:1 in the hybrid fabric according to the present invention.

The HPPE fibers may be used in weft and/or in warp directions in the sheet according to the present invention. Such construction shows better structural properties. Other constructions of the sheet may include non-polymeric fibers, preferably fibers selected from the group consisting of basalt fibers, glass fibers and carbon fibers and/or mixtures thereof in warp direction and HPPE fibers only in weft direction or non-polymeric fibers, preferably fibers selected from the group consisting of basalt fibers, glass fibers and carbon fibers and/or mixtures thereof and HPPE fibers in warp direction and HPPE fibers only in weft direction.

The hybrid sheet according to the present invention can be manufactured by any process known in the art, and preferably by a process comprising the steps of:
a) providing high performance polyethylene (HPPE) fibers, a polymeric resin and non-polymeric fibers, wherein the polymeric resin is selected from a group consisting of a homopolymer of ethylene, a homopolymer of propylene, a copolymer of ethylene, and a copolymer of propylene and wherein said polymeric resin has a density as measured according to ISO1183-2004 in the range from 860 to 970 kg/m³, a peak melting temperature in the range from 40 to 140° C. and a heat of fusion of at least 5 J/g;
b) applying a solvent solution or a suspension, preferably an aqueous suspension of the polymeric resin to the HPPE fibers before, during or after assembling, with the solution or suspension preferably being applied before assembling the HPPE fibers;
c) assembling the HPPE fibers and the non-polymeric fibers to form a sheet;
d) at least partially drying the solution or suspension of the polymeric resin, preferably during the assembling step c) being carried out before or after step d), preferably step d) being carried out before step c);
to obtain a hybrid sheet upon completion of steps a), b), c) and d);
e) optionally applying a temperature in the range from the melting temperature of the resin to 153° C. to the sheet of step c) before, during and/or after step d) to at least partially melt the polymeric resin;
f) optionally applying a matrix material, preferably impregnating the hybrid sheet with a matrix material in order to obtain a hybrid sheet; and
g) optionally applying a pressure to the sheet during and/or after step f) to at least partially compact the hybrid sheet.

According to the process of the present invention, preferably an aqueous suspension is applied to the HPPE fibers, more preferably an aqueous suspension is applied onto the HPPE fibers, most preferably an aqueous suspension is applied onto the HPPE fibers as a coating. Such application of suspension takes place before, during or after the HPPE fibers are assembled into a sheet, but most preferably before HPPE fibers are assembled. By aqueous suspension is understood that particles of the polymeric resin are suspended in water acting as non-solvent. The concentration of the polymeric resin may widely vary and is mainly limited by the capability to formulate a stable suspension of the resin in water. A typical range of concentration is between 0.5 and 60 vol % of polymeric resin in water, whereby the volume percentage is the volume of polymeric resin in the total volume of aqueous suspension. Preferred concentration are between 1 and 40 wt %, more preferably between 1 and 30 wt %, most preferably between 3 and 20 wt %. Further preferred concentrations of the polymeric resin is at least 1; 2; 3; 5; 10; 15 or 20 vol %, relative to the total volume of polymeric resin in the total volume of aqueous suspension or solvent solution and at most 30; 35; 40 or 50 vol %, relative to the total volume of the polymeric resin in the total volume of aqueous suspension or solvent solution. Such preferred higher concentrations of polymeric resin applied in aqueous suspension may have the advantage of providing hybrid sheets with higher concentration while reducing the time and energy required for the removal of the water from the sheet. The suspension or solution may further comprise additives such as ionic or non-ionic surfactants, tackifying resins, stabilizers, anti-oxidants, colorants or other additives modifying the properties of the suspension or solution, the resin and or the prepared composite sheet.

Preferably, the suspension is substantially free of additives that may act as solvents for the polymeric resin. Such suspension may also be referred to as solvent-free. By solvent is herein understood a liquid in which at room temperature the polymeric resin is soluble in an amount of more than 1 wt % whereas a non-solvent is understood a liquid in which at room temperature the polymeric resin is soluble in an amount of less than 0.1 wt %. The concentrations of the polymeric resin in the solvent solution may have the same values as the polymer resin concentrations mentioned herein for the aqueous suspension.

The application of the suspension or solution to the HPPE fibers may be done by methods known in the art and may depend amongst others on the moment the suspension is added to the HPPE fibers, the concentration and viscosity of the suspension. The suspension or solution may for example be applied to the HPPE fibers by spraying, dipping, brushing, transfer rolling or the like, especially depending on the intended amount of polymeric resin present in the hybrid composite sheet of the invention. The amount of suspension present in the sheet may vary widely in function of the intended application of the composite sheet and can be adjusted by the employed method but also the properties of the suspension or solution.

Once the polymeric solution or suspension is applied to the HPPE fibers, the impregnated HPPE fibers formed thereof, preferably the assembly comprising the impregnated fibers, is at least partially dried. Such drying step involves the removal, e.g. the evaporation of at least a fraction of the water or solvent present in the assembly. Preferably the majority, more preferably essentially all water or solvent is removed during the drying step, optionally in combination with other components present in the impregnated assembled sheet. Drying, i.e. the removal of water or solvent from the suspension, may be done by methods known in the art. Typically the evaporation of water or solvent involves an increase of the temperatures of the sheet close to or above the boiling point of water or solvent. The temperature increase may be assisted or substituted by a reduction of the pressure and or combined with a continuous refreshment of the surrounding atmosphere. Typical drying conditions for aqueous suspensions are temperatures of between 40 and 130° C., preferably between 50 and 120° C.

The preferred process of the invention may optionally comprise a step wherein the hybrid sheet is heated to a temperature in the range from the melting temperature of the polymeric resin to 153° C., before, during and/or after the partially drying of the HPPE fibers. Heating of the HPPE fibers may be carried out by keeping the sheet for a dwell time in an oven set at a heating temperature, subjecting the impregnated sheet to heat radiation or contacting the layer with a heating medium such as a heating fluid, a heated gas stream or a heated surface. Preferably, the temperature is at least 2° C., preferably at least 5° C., most preferably at least 10° C. above the peak melting temperature of the polymeric resin. The upper temperature is at most 153° C., preferably at most 150° C., more preferably at most 145° C. and most preferably at most 140° C., to prevent deterioration of the (strength) properties of the fiber. The dwell time is preferably between 2 and 200 seconds, more preferably between 3 and 60 seconds, most preferably between 4 and 30 seconds. In a preferred embodiment, the heating of the sheet of this step overlaps, more preferably is combined with the drying step. It may prove to be practical to apply a temperature gradient to the impregnated sheet whereby the temperature is raised from about room temperature to the maximum temperature of the heating step over a period of time whereby the impregnated sheet will undergo a continuous process from drying of the suspension to at least partial melting of the polymeric resin.

In a further optional step of the process of the invention, the hybrid composite sheet obtained with step f) is at least partially compacted by applying a pressure, preferably at enhanced temperature, e.g. about 50° C., and the matrix material may be cured at elevated temperature, e.g. about 50° C. Said pressure may be applied by compression means known in the art, which may amongst others be a calender, a smoothing unit, a double belt press, or an alternating press. The compression means form a gap through which the layer will be processed. Pressure for compaction generally ranges from 100 kPa to 1 MPa, preferably from 150 to 500 kPa. The compression is preferably performed after at least partially drying the hybrid composite sheet, more preferably during or after the optional step of applying a temperature, while the temperature of the sheet is in the range from the melting temperature of the polymeric resin to 153° C. In a specific embodiment of the invention, a compression of the hybrid composite sheet may be achieved by placing the impregnated sheet during or after the impregnation step or the partial drying step under tension on a curved surface. The tension on that curved surface creates pressure between the fibers and surface. Filament winding is a well-known production process for composites where this effect occurs, and it can advantageously be applied in conjunction with the present invention.

The invention also relates to the hybrid sheet obtainable by the process according to the present invention. Such hybrid sheet comprises or consists of i) HPPE fibers; ii) a polymeric resin, wherein the polymeric resin is selected from a group consisting of a homopolymer of ethylene, a homopolymer of propylene, a copolymer of ethylene, and a copolymer of propylene, wherein the polymeric resin has a density as measured according to ISO1183-2004 in the range from 860 to 970 kg/m³, a melting temperature in the range from 40 to 140° C. and a heat of fusion of at least J/g; iii) non-polymeric fibers; and iv) optionally a matrix material. Such hybrid sheet is subject to the preferred embodiments and potential advantages as discussed above or below in respect of the preferred process, whereas the preferred embodiments for the hybrid sheet potentially apply vice versa for the preferred process.

Preferably, the hybrid sheet according to the present invention comprises at least one network of the fibers. By network is meant that the fibers are arranged in configurations of various types, e.g. a knitted or woven fabric, a non-woven fabric with a random or ordered orientation of the fibers, a parallel array arrangement also known as unidirectional UD arrangement, layered or formed into a fabric by any of a variety of conventional techniques. Preferably, said sheets comprise at least one network of said fibers. More preferably, said sheets comprise a plurality of networks of the fibers.

The hybrid sheet according to the present invention may optionally comprise iv) a matrix material. Any matrix material, e.g. relative to thermoplastic or on thermoset polymers known to the skilled person in the art can be used. Preferred examples of the matrix material include a thermoplastic or a thermoset resin, preferably a thermoset resin, more preferably an epoxy resin, a polyurethane resin, a vinylester resin, a phenolic resin, a polyester resin and/or mixtures thereof. The total concentration of the matrix material may be from 80 to 30 vol %, preferably from 70 to vol %, yet preferably from 60 to 40 vol %, relative to the total volume of the hybrid sheet. Higher amount of matrix material adds disadvantageously to the total weight of the hybrid composite sheet. Some voids may be present in the hybrid composite sheet. Preferably, no voids are present in the hybrid sheet according to the present invention. Any curing agent known in the art may be added to the matrix material, in any conventional amounts, by using any known method.

The hybrid sheet according to the present invention may contain at least one monolayer. The term monolayer refers to a layer of fibers comprising HPPE fibers comprising the polymeric resin and non-polymeric fibers and optionally a matrix material. The monolayer may be a unidirectional monolayer. The term unidirectional mono-layer refers to a layer of unidirectionally oriented fibers, i.e. fibers that are essentially oriented in parallel. Preferably, the hybrid sheet according to the present invention is selected from the list consisting of a woven fabric, a non-woven fabric, a knitted fabric, a layer of unidirectional oriented fibers, a cross-ply of unidirectional oriented fibers or combination thereof.

The hybrid sheet according to the present invention may comprise at least one, preferably at least 2, monolayers comprised of unidirectionally (UD) oriented fibers and the polymeric resin. Preferably, the fiber direction in each monolayer is rotated with respect to the fiber direction in an adjacent monolayer. Several monolayers may be preassembled before their use as hybrid sheet. For that purpose, a set of 2, 4, 6, 8 or 10 monolayers may be stacked such that the fiber direction in each monolayer is rotated with respect to the fiber direction in an adjacent monolayer, followed by consolidation. Consolidation may be done according to the prior art, e.g. by the use of pressure and temperature to form a preassembled sheet, or sub-sheet. Pressure for consolidation generally ranges from 1-10 bar while temperature during consolidation typically is in the range from 60 to 140° C.

It is important that the polyolefin resin of the suspension softens or melts at higher temperatures. So far, such suspensions have not yet been applied in combination with HPPE fibers. Surprisingly, they provide improved performance in various products especially products comprising oriented UHMWPE fibers.

The combination of an oriented HPPE fiber with polyolefin polymers is described in EP2488364 where melting of the polyolefin polymer is employed to provide a flexible but strong sheets. However, such products contain substantial amounts of polyolefin resin or provide an inadequate wetting/distribution of the resin throughout the HPPE structure. Products such as described in EP2488364 are substantially different from the ones prepared according to the method according to the present invention, amongst others because in the currently presented methods and products the distribution of the polymeric resin is throughout the sheets providing improved mechanical properties. Furthermore, the impregnation of the HPPE fiber structure takes place at substantially lower temperatures and in the absence of hydrocarbon solvents which may avoid alterations of the HPPE fibers and/or their surfaces. After impregnation, the water is removed and the remainder of the suspension is present in a lower amount. The suspension may contain at least one surface active ingredient such as ionic or non-ionic surfactant.

Sheets comprising HPPE fibers coated with a polymer having ethylene or propylene crystallinity are also described in EP0091547, whereby mono- or multifilament fibers are treated at high temperatures with solutions of the polymer in hydrocarbon solvents at a concentration of up to 12 g/L. However, through such hot solvent treatment, the fibers may contain residual amounts of the employed hydrocarbon solvent negatively affecting fiber properties. Furthermore the treatment of the HPPE fiber at high temperature with a hydrocarbon solvent may affect structural properties of the fibers, especially through diffusion of the hydrocarbon solvent and/or polymer into the HPPE filaments. The fiber-polymer interface may be modified by partial etching and dissolution of the HPPE which may affected amongst others the interface as well as the bulk properties of the HPPE fibers. Moreover, solvent rests may diffuse out of the hybrid composite during service life. This may be highly undesired, e.g. for interiors of cars (and other small spaces containing humans). In contrast, the present process may be performed at room temperature and employs a non-solvent for the HPPE, i.e. water. Accordingly, the fibers and composite sheets produced by the process of the present invention may have a better retention of the structural properties of the HPPE fibers. The fibers may also present a different surface structure amongst which a better discerned HPPE-coating interfaces compared to the fibers treated at high temperature with a hydrocarbon solvent since no hydrocarbon solvent and/or polymer may diffuse into the HPPE fiber. Furthermore, the process and products described in EP0091547 are limited by the amount of polymer present in the hydrocarbon solutions and hence applied to the HPPE fibers. The solutions are limited by their increasing viscosities and high amounts of polymer coating may only be applied by repetition of the coating operation.

The hybrid composite sheet according to the present invention can be made with any process known in the art, for instance as described in the unpublished yet patent application EP16177536.6. Suitable examples of known such processes include pre-impregnated fabrics process, hand lay-up, resin transfer molding or vacuum infusion process, autoclave process, press process.

The present invention also directs to articles comprising the hybrid sheet according to the invention. The articles can be used in automotive field (e.g. wheel rims for cars and motorcycles, interiors for cars, impact panels), aerospace field (e.g. aircrafts, satellites), as sports equipment (e.g. bicycles, bicycles frames, cockpits, seats, hockey sticks, tennis and squash rackets, baseball bats, ski and snowboards, surfboards, paddle boards, helmets such as for cycling, football, climbing, motorsport), in marine filed (e.g. boat hulls, masts, sails, boats), military, wind and renewable energy (e.g. wind turbines, tidal turbines) fields.

Furthermore, the invention relates to the use of the hybrid sheet according to the present invention in various application fields, such as automotive (e.g. wheel rims for cars and motorcycles, interiors for cars, impact panels), aerospace (e.g. aircrafts, satellites), sports equipment (e.g. bicycles, bicycles frames, baseball bats, cockpits, seats, hockey sticks, tennis and squash rackets, ski and snowboards, surfboards, paddle boards, helmets such as for cycling, football, climbing, motorsport), marine (e.g. boat hulls, masts, sails, boats), military, wind and renewable energy (e.g. wind turbines, tidal turbines). When the hybrid sheet according to the present invention is used in various applications, these applications show an improved combination of properties, flexural strength and bending strength, while maintaining high impact resistance.

The invention will be further explained by the following examples and comparative experiment, however first the methods used in determining the various parameters useful in defining the present invention are hereinafter presented.

### EXAMPLES

### Methods

Dtex: yarn's or filament's titer was measured by weighing 100 meters of yarn or filament, respectively. The dtex of the yarn or filament was calculated by dividing the weight (expressed in milligrams) by 10.
Heat of fusion and peak melting temperature have been measured according to standard DSC methods ASTM E 794 and ASTM E 793 respectively at a heating rate of 10K/min for the second heating curve and performed under nitrogen on a dehydrated sample.
The density of the polymeric resin is measured according to ISO 1183-2004.
IV: the Intrinsic Viscosity is determined according to method ASTM D1601(2004) at 135° C. in decalin, the dissolution time being 16 hours, with BHT (Butylated Hydroxy Toluene) as anti-oxidant in an amount of 2 g/I solution, by extrapolating the viscosity as measured at different concentrations to zero concentration.
Tensile properties of HPPE fibers: tensile strength (or strength) and tensile modulus (or modulus) are defined and determined on multifilament yarns as specified in ASTM D885M, using a nominal gauge length of the fiber of 500 mm, a crosshead speed of 50%/min and Instron 2714 clamps, of type “Fiber Grip D5618C”. On the basis of the measured stress-strain curve the modulus is determined as the gradient between 0.3 and 1% strain. For calculation of the modulus and strength, the tensile forces measured are divided by the titre, as determined above; values in GPa are calculated assuming a density of 0.97 g/cm³ for the HPPE.
Tensile properties of fibers having a tape-like shape: tensile strength, tensile modulus and elongation at break are defined and determined at 25° C. on tapes of a width of 2 mm as specified in ASTM D882, using a nominal gauge length of the tape of 440 mm, a crosshead speed of 50 mm/min.
Tensile strength and tensile modulus at break of the polyolefin resin were measured according ISO 527-2.
Number of olefinic branches per thousand carbon atoms was determined by FTIR on a 2 mm thick compression moulded film by quantifying the absorption at 1375 cm-1 using a calibration curve relative to NMR measurements as in e.g. EP 0 269 151 (in particular pg. 4 thereof).
Areal density (AD) of a sheet was determined by measuring the weight of a sample of preferably 0.4 m×0.4 m with an error of 0.1 g. The areal density of a tape was determined by measuring the weight of a sample of preferably 1.0 m×0.1 m with an error of 0.1 g.
Flexural strength and modulus were measured by a 3-point flexural test according to ASTM D790-07, on specimens with a width of 12.7 mm and an L/D ratio of 16. The warp direction of the fibers was the length direction of the specimens in all cases. The modulus was determined between the points with 1% and 1.9% flexural strain. The flexural strength was determined at maximum load.
Short beam flexural strength (also called interlaminar shear strength testing ILSS) was measured by a 3-point Flexural test similar to ASTM D790-07, on specimens with a length of 30 mm, a width of 7 mm and a reduced load span of about 22 mm such that a L/D of 5 was obtained. This low L/D value promotes interlaminar shear failure, between the fibers in the plane of the specimen, instead of failure of the fibers. The length direction was in the fiber load direction in all cases. Such short specimens typically fail by shearing along the warp fibers when subjected to 3-point bending. Thus, a measure for the resistance against that inter-laminar shear stress (ILSS) can be obtained. ILSS is calculated from the maximum load (Fmax), according to formula: ILSS value=0.75×Fmax/(W*D), where W is the width, being 7 mm for the present specimens and D is the measured thickness of the hybrid composite sheet.
Tensile tests on the composites were performed according to ASTM D3039, using tabs at the clamped ends of the specimens, in order to prevent clamping damage.

Comparative Experiment 1

3 yarns of glass fiber of 136 tex with a 1383 sizing commercially available from PPG were assembled into one yarn with a titer of 408 tex glass fibers. A woven fabric was produced with a warp of these assembled 408 tex glass fibers and yarns of gel spun UHMWPE fibers, commercially available as Dyneema® SK75 yarn of 176 tex and having a tenacity of 3.3 N/tex. 6.8 yarns per cm were applied in the warp yarn and a total of 136 of yarns were applied in the warp yarn. The first two yarns were glass fibers, then the third yarn was Dyneema® fibers. This was repeated till the total number of yarns of 136 was reached. So, every third yarn was a Dyneema® yarn, i.e. about 33 vol % Dyneema®, relative to the total volume of the fabric. The fabric was made with a weft of 43 tex glass fibers, such that the volume of the weft fibers was 9 vol % of the total fabric volume. The aerial density of the fabric was 246 grams per square meter. The width of the fabric was 20 cm.

### Example 1

Comparative Experiment 1 was repeated, but now the Dyneema® SK75 yarn having a tenacity of 3.3 N/tex used was coated with a diluted suspension of an acrylate modified polyolefin, i.e. ethylene acrylic acid (EAA) copolymer with a melting peak at 78° C. and a heat of fusion of 29 J/g in water, purchased from Michelman under the trade name of Michem® Prime 5931. The concentration of EAA in water was 2 vol %, related to the total volume of the hybrid sheet. The dilution was chosen such that that about 2 vol % aqueous dispersion was added to the Dyneema® SK75 yarn. The coated yarn was dried in an oven at 130° C., such that all water evaporated and the EAA reached the melting point, providing a good connection to the Dyneema SK75 yarn after cooling to room temperature. The concentration of EAA on the yarn was about 1 vol %, relative to the total volume of the hybrid sheet. The final linear density of the yarn was about 180 tex. The resulting aerial density of the final woven fabric, i.e. the hybrid sheet was negligibly higher than the density of the woven fabric of Comparative Experiment 1.

Comparative Experiment 2

A hybrid composite sheet was made by stacking 10 woven fabrics obtained with Comparative Experiment 1 on top of each other from, such that the warp fibers in the yarn were all in the same direction. The stack was then impregnated with 55 vol %, relative to the total volume of the hybrid sheet of an epoxy resin commercially available as L 285 from Hexion with Hardener 285 and cured under near vacuum (about 150 mbar) at 50° C. during one hour. The total fiber volume content was 45 vol %, relative to the total volume of the hybrid sheet. The resulting average thickness of the hybrid composite sheet was 2.75 mm. The flexural modulus of the hybrid composite sheet of Comparative Example 2 was 17.8 GPa and the flexural strength was 405 MPa.

### Example 2

A hybrid composite sheet was made by stacking on top of each other 10 fabrics obtained according to Example 1, such that the warp fibers were all in the same direction and then the stack was impregnated with 56 vol %, relative to the total volume of the hybrid sheet of an epoxy resin commercially available as L 285 from Hexion with Hardener 285 and then cured under near vacuum (about 150 mbar) at 50° C. during one hour. The resulting average thickness of the hybrid composite sheet was 2.9 mm. The total fiber volume was 43 vol %, relative to the total volume of the hybrid sheet. The flexural modulus of the hybrid composite sheet of Example 2 was 18.9 GPa and the flexural strength was 477 MPa (about 20% higher than of the flexural strength of the hybrid composite sheet obtained according to Comparative Experiment 2).

Comparative Experiment 3

A hybrid composite sheet was made by stacking 15 fabrics on top of each obtained according to Comparative Experiment 1, such that the warp fibers were all in the same direction and then impregnated with an epoxy resin commercially available as L 285 from Hexion with Hardener 285 and then cured under near vacuum (about 150 mbar) at 50° C. during one hour. The resulting average thickness of the hybrid composite sheet was 4.4 mm. The total fiber volume content was 43 vol %, relative to the total volume of the hybrid sheet. The apparent ILSS was 14.4 MPa.

### Example 3

A hybrid composite sheet was made by stacking 15 fabrics from Example 1 on top of each other, such that the warp fibers were all in the same direction and then impregnated with an epoxy resin commercially available as L 285 from Hexion with Hardener 285 and cured under near vacuum at 50° C. during one hour. The resulting average thickness of the hybrid composite sheet was 4.3 mm. The total fiber volume content was 44 vol %, relative to the total volume of the hybrid sheet. The apparent ILSS of the sample obtained according to Example 3 was 16.5 MPa.

Comparative Experiment 4

Comparative experiment 1 was repeated, but now all yarns in the warp direction were 408 tex glass fibers, the aerial density of the fabric was 300 grams per square meter. It should be noted that the volume of a 176 tex Dyneema® fiber is about the same as that of a 408 tex glass fiber, because the density of Dyneema® is 0.975 grams/cm³ and glass has a density of 2.55 grams/cm³. The about equal volume follows from the elementary calculation: 408*0.975/2.55=156 tex, so close to the tex number of 176 of the Dyneema® yarn. So, composites made from fabrics according to Comparative Experiment 1 and Comparative Experiment 4, can be compared on the basis of equal fabric fiber volume.

Comparative Experiment 5

A composite sheet was made by stacking 2 woven fabrics obtained with Comparative Experiment 4 on top of each other from, such that the warp fibers in the yarn were all in the same direction. The stack was then impregnated with 62 vol %, relative to the total volume of the composite sheet of an epoxy resin commercially available as L 285 from Hexion with Hardener 285 and cured under near vacuum (about 150 mbar) at 50° C. during one hour. The fiber volume content was 38%, based on the total volume of the composite sheet. The specimens were subjected to tensile tests. The measured modulus was 15.1 GPa, and the measured fracture strength was 438 MPa.

Comparative Experiment 6

A hybrid composite sheet was made by stacking 2 woven fabrics obtained with Comparative Experiment 1 on top of each other from, such that the warp fibers in the yarn were all in the same direction. The stack was then impregnated with 59 vol %, relative to the total volume of the composite sheet of an epoxy resin commercially available as L 285 from Hexion with Hardener 285 and cured under near vacuum (about 150 mbar) at 50° C. during one hour. The fiber volume content was 41%, based on the total volume of the composite sheet. The specimens were subjected to tensile tests. The measured modulus was 16.1 GPa, and the measured fracture strength was 493 MPa.

### Example 4

A hybrid composite sheet was made by stacking 2 woven fabrics obtained with Example 1 on top of each other from, such that the warp fibers in the yarn were all in the same direction. The stack was then impregnated with 71 vol %, relative to the total volume of the composite sheet of an epoxy resin commercially available as L 285 from Hexion with Hardener 285 and cured under near vacuum (about 150 mbar) at 50° C. during one hour. The fiber volume content was 28%, based on the total volume of the composite sheet. The specimens were subjected to tensile tests. The measured modulus was 13.5 GPa, and the measured fracture strength was 405 MPa.

It was argued before that high fiber volume (vf) content implies a higher strength, because the fibers are the load carrying composite backbone. This is well known in the art as fiber dominated behavior. The resin rather connects the fibers together, so the best comparison of the different strength properties (except ILLS which is a matrix dominated property) is done by normalizing strength against fiber volume content. The same applies to the modulus, because also the modulus in fiber direction is known as a fiber dominated property. Therefore, the fiber dominated properties are presented in the table below, also after normalizing against the fiber volume content, vf. E is the modulus in GPa and S is the strength in MPa

| | Flexural test | | Tensile test | | |
|---|---|---|---|---|---|
| | CE 2 | Example 2 | CE 5 | CE 6 | Example 4 |
| E [GPa] | 18.8 | 18.9 | 15.1 | 16.1 | 13.5 |
| S [MPa] | 405 | 477 | 438 | 493 | 405 |
| E/vf | 41.8 | 44.0 | 39.7 | 39.3 | 48.2 |
| S/vf | 900 | 1109 | 1153 | 1202 | 1446 |

The results obtained clearly demonstrate that a hybrid sheet showing improved structural properties, e.g. improved flexural strength and bending strength, thus a lower sensitivity to delamination, while maintaining high impact resistance properties, and thus enabling more and various application opportunities was obtained by the present invention. Moreover, the real difference in the flexural strength and modulus values obtained according to Examples and the Comparative Experiments may be even higher as typically the production of composite samples is subject to some scatter and, as a consequence, the Comparative Experiment 2 has a higher fiber volume content than Example 2, thus being more advantageous apparently than Example 2. This is also related to a slight difference in the thickness between the samples of the Examples and the Comparative Experiments but the effect that may result from this difference is typically ruled out by the beam theory equations in the standard applied for ILSS method. Furthermore, it is especially advantageously to have better structural properties at lower fiber volume content.

1. A hybrid sheet comprising:
i) high-performance polyethylene (HPPE) fibers;
ii) a polymeric resin, wherein the polymeric resin is selected from a group consisting of a homopolymer of ethylene, a homopolymer of propylene, a copolymer of ethylene, and a copolymer of propylene, wherein the polymeric resin has a density as measured according to ISO1183-2004 in the range from 860 to 970 kg/m³, a melting temperature in the range from 40 to 140° C. and a heat of fusion of at least 5 J/g; and
iii) non-polymeric fibers.

2. The hybrid sheet according to claim 1, wherein the non-polymeric fibers are selected from a group consisting of carbon fibers, glass fibers, wollastonite fibers, basalt fibers and/or mixtures thereof.

3. The hybrid sheet according to claim 1, wherein the HPPE fibers are continuous filaments or staple fibers.

4. The hybrid sheet according to claim 1, wherein the HPPE fibers are prepared by a melt spinning process, a gel spinning process or solid state powder compaction process.

5. The hybrid sheet according to claim 1, wherein the polymeric resin is applied as a coating on the HPPE fibers, preferably the polymeric resin is applied as a coating obtained from aqueous suspension on the HPPE fibers.

6. The hybrid sheet according to claim 1, wherein the HPPE fibers have a tenacity of at least 1.0 N/tex, preferably at least 1.5 N/tex, more preferably at least 1.8 N/tex.

7. The hybrid sheet according to claim 1, wherein the HPPE fibers comprise ultra-high molecular weight polyethylene (UHMWPE), preferably the HPPE fibers substantially consist of UHMWPE.

8. The hybrid sheet according to claim 1, wherein the amount of polymeric resin in the hybrid sheet is from 1 to 10 vol %, relative to the total volume of the hybrid sheet.

9. The hybrid sheet according to claim 1, wherein the density of the polymeric resin is in the range from 870 to 930 kg/m³, preferably from 870 to 920 kg/m³, more preferably from 875 to 910 kg/m³.

10. The hybrid sheet according to claim 1, wherein the polymeric resin comprises an ethylene acrylic acid copolymer.

11. The hybrid sheet according to claim 1, further comprising a matrix material, preferably the matrix material is a thermoset resin, more preferably a resin selected from a group consisting of an epoxy resin, a polyurethane resin, a vinylester resin, a phenolic resin, a polyester resin and/or mixtures thereof.

12. A process for manufacturing the hybrid sheet according to claim 1, the process comprising the steps of:
a) providing high performance polyethylene (HPPE) fibers, a polymeric resin and non-polymeric fibers, wherein the polymeric resin is selected from a group consisting of a homopolymer of ethylene, a homopolymer of propylene, a copolymer of ethylene, and a copolymer of propylene and wherein said polymeric resin has a density as measured according to ISO1183-2004 in the range from 860 to 970 kg/m³, a peak melting temperature in the range from 40 to 140° C. and a heat of fusion of at least 5 J/g;
b) applying a solvent solution or a suspension, preferably an aqueous suspension of a polymeric resin to the HPPE fibers before, during or after assembling, with the solution or suspension preferably being applied to the HPPE fibers before assembling the HPPE fibers;
c) assembling the HPPE fibers and the non-polymeric fibers to form a sheet;
d) at least partially drying the solution or suspension of the polymeric resin, preferably during the assembling step c) being carried out before or after step d), preferably step d) being carried out before step c);
to obtain a hybrid sheet upon completion of steps a), b), c) and d);
e) optionally applying a temperature in the range from the melting temperature of the resin to 153° C. to the sheet of step c) before, during and/or after step d) to at least partially melt the polymeric resin;
f) optionally applying a matrix material, preferably impregnating the hybrid sheet with a matrix material in order to obtain a hybrid composite sheet; and
g) optionally applying a pressure to the sheet during and/or after step f) to at least partially compact the hybrid composite sheet.

13. The process according to claim 12, wherein the concentration of polymeric resin in the aqueous suspension is at most 30 vol %, relative to the total volume of the aqueous suspension.

14. An article comprising the hybrid sheet according to claim 1, the article being selected from wheel rim for cars, bicycles and motorcycles, interiors for cars, impact panels, aircrafts, satellites, bicycles frames, cockpits, seats, hockey sticks, baseball bats, tennis and squash rackets, ski and snowboards, surfboards, paddle boards, helmets such as for cycling, football, climbing, motorsport, boat hulls, masts, sails, boats, wind turbines and tidal turbines.

15. Use of the article according to claim 14 in automotive field, preferably in wheel rims for cars and motorcycles, interiors for cars, impact panels; in aerospace field, preferably in aircrafts and satellites; in sports equipment, preferably in bicycles, bicycles frames, cockpits, seats, hockey sticks, baseball bats, tennis and squash rackets, ski and snowboards, surfboards, paddle boards, helmets such as for cycling, football, climbing, motorsport; in marine field, preferably in boat hulls, masts, sails, boats; in military field; and in wind and renewable energy field, preferably in wind turbines and tidal turbines.
